(19) United States
(12) Patent Application Publication
(10) Pub. No.: US 2003/0112763 A1
(43) Pub. Date: Jun. 19, 2003

(54) Communications channel performance determination for high-speed access

(76) Inventors: Gin Liu, Brampton (CA); Michael A. Campbell, Brampton (CA)

Correspondence Address: Dan C. Hu, TROP, PRUNER & HU, P.C., Ste. 100, 8554 Katy Freeway, Houston, TX, 77024, US

(21) Appl. No.: 10/024,052

(22) Filed: Dec. 17, 2001

(51) Int. Cl. H04L 12/66

(52) U.S. Cl. 370/252; 370/352

(57) ABSTRACT

A method and apparatus to determine performance of a subscriber loop includes using a database containing information pertaining to physical characteristics of a subscriber loop (or group of subscriber loops). Based on the information, a data communications speed of the subscriber loop is estimated. An actual data communications speed of the subscriber loop is determined and compared to the estimated data communications speed. The information in the database is updated based on the comparison.

### TECHNICAL FIELD

This invention relates generally to determining performance of a communications channel for high-speed access, such as xDSL (Digital Subscriber Line) access.

### BACKGROUND

With improved communications technology, data communications speeds over various types of data networks, such as the Internet, have dramatically improved. Examples of data communications include electronic mail, web browsing, file transfer, packet-switched voice sessions, electronic gaming sessions, and so forth. Increasingly, high-bandwidth channels are needed for such communications, which often involve the exchange of graphical, video, and/or audio data.

Most existing subscriber loops were designed for voice telephony, not high-speed data services. Consequently, subscriber loops commonly include wire gauge changes, bridged taps (unused extension lines), and other anomalies that may limit the available bandwidth of subscriber loops. Also, certain types of equipment, such as load coils, voice frequency repeaters, loop extenders, private switch systems, line intercept equipment, and so forth, are incompatible with high-speed or high-bandwidth data services.

Consequently, before a service provider is able to provide high-speed data service to a given customer or geographic region, technicians may have to be dispatched to each customer premise to determine whether the subscriber loop(s) are able to support high speed data services. Often, the qualification process takes a relatively large amount of time.

In some cases, the qualification process is based on records kept by service providers of characteristics of subscriber loops. However, records of subscriber loops and equipment used in conjunction with the subscriber loops are often inaccurate. For example, if the service provider does not know the actual characteristics of a subscriber loop, the service provider may choose instead to enter default values to approximate the characteristics of the subscriber loop. In many instances, such default values diverge substantially from actual characteristics of the subscriber loop. As a result, the process of qualifying a subscriber loop for high-speed data services may produce inaccurate results.

### SUMMARY

In general, according to one embodiment, a method of determining performance of a communications channel comprises calculating a data communications speed of the communications channel based on records used for high-speed access qualification, and determining an actual data communications speed of the communications channel. A comparison is made between the actual data communications speed and the calculated data communications speed to determine if an update of the records is needed.

Other or alternative features will become apparent from the following description, from the drawings, and from the claims.

### BRIEF DESCRIPTION OF THE DRAWINGS

FIG. 1 is a block diagram of an example communications network incorporating an embodiment of the invention.

FIG. 2 is a flow diagram of a process of determining accuracy of information pertaining to physical characteristics of subscriber loops in the communications network of FIG. 1.

FIG. 3 is a flow diagram of a loop qualification process performed in the process of FIG. 2.

FIG. 4 is a block diagram of components of a loop qualification system and a technical support station used in the communications network of FIG. 1.

### DETAILED DESCRIPTION

In the following description, numerous details are set forth to provide an understanding of the present invention. However, it will be understood by those skilled in the art that the present invention may be practiced without these details and that numerous variations or modifications from the described embodiments may be possible. For example, although reference is made to high-speed or high-bandwidth data services in some embodiments, other embodiments may employ other types of data services.

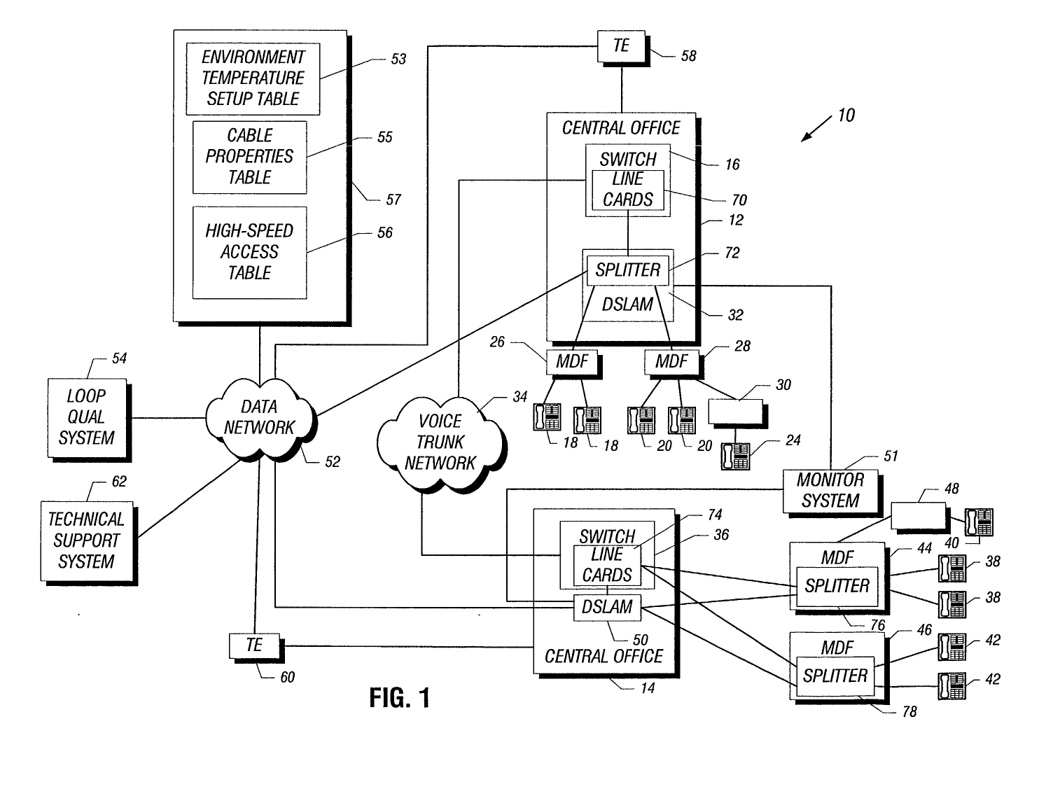

FIG. 1 shows an example communications network 10 that includes a first central office facility 12 and a second central office facility 14. Note that the arrangement of FIG. 1 is shown by way of example only, since many other arrangements are possible in other embodiments. The central office facilities 12 and 14 are operated by a local exchange carrier (LEC), usually a telephone company or other service provider. Although reference is made to “central office facility” in the described embodiments, equipment used in other types of facilities can be employed in other embodiments.

The central office facility 12 includes a switch 16 that controls the exchange of signaling and bearer traffic between subscriber stations 18, 20, 24, and other switches or stations. The switch 16 makes routing decisions based on some parameter, such as digits dialed by a user. Examples of subscriber stations 18, 20, and 24 include telephones and other voice devices. For data services, the stations 18, 20, and 24 include computers, personal digital assistants, and the like. More generally, the stations 18, 20, and 24 are referred to as customer premise equipment.

In the illustrated arrangement of FIG. 1, the central office facility 12 is further connected to main distribution frames (MDFs) 26 and 28, which are in turn coupled to subscriber stations 18, 20, and 24 over respective subscriber loops (also referred to as local loops). A subscriber or local loop is usually a two-wire circuit that carries information signals in both directions over the same physical link or path. Typically, such a circuit includes a single twisted pair, copper wire connection. However, in other embodiments, other types of subscriber loops can be used. More generally, instead of reference to subscriber loops, subscriber stations are coupled by “communications channels” to connection equipment, which may include MDFs, switches, and other equipment.

Each MDF is effectively a wire center at which wires (which form the subscriber loops) from customer premises terminate. The MDF has a series of cross-connections to connect the subscriber loops to the switch 16 or to another location.

The MDF 28 is coupled to the subscriber station 24 through an intermediate system 30, which can be one of many types of devices. For example, the intermediate system 30 can include a load coil, which is used to improve transmission of signals in the voice frequency band; a voice frequency repeater, which is used to amplify and retransmit signals in the voice frequency band; a loop extender, which is used to amplify signals in the voice frequency band; a private switch system, such as a key telephone system or a private branch exchange system, connected to a number of subscriber stations; intercept equipment such as a voice recording system to record voice frequency payload; and other equipment. Any one of the above-listed devices placed between the MDF 28 and the subscriber station 24 is incompatible with xDSL services and thus prevents use of the subscriber loop between the MDF 28 and the subscriber station 24 for xDSL services. However, in other embodiments employing other types of high-speed data services, such devices may be compatible and thus do not prevent the provision of such other types of high-speed data services.

In the example shown in FIG. 1, the subscriber loop between the MDF 28 and the subscriber station 24 cannot be used for xDSL services, while the subscriber loops between the MDF 28 and subscriber stations 20, and between the MDF 26 and the subscriber stations 18 may be used for xDSL services.

The term xDSL is considered a generic (the letter ‘x’ means generic) term for Digital Subscriber Line equipment and services, including ADSL (Asymmetrical Digital Subscriber Line), HDSL (High-Bit-Rate Digital Subscriber Line), IDSL (ISDN-Like Digital Subscriber Line), RDSL (Rate Adaptive Digital Subscriber Line), SDSL (Symmetric Digital Subscriber Line), and VDSL (Very High Speed Digital Subscriber Line). “xDSL” technologies are considered high-bandwidth or high-speed technologies that have the capacity to operate over existing POTS lines, or twisted pair lines, that lead to user residence or businesses. Some xDSL lines are symmetrical—that is, they have the same bandwidth in both directions, and some are asymmetrical—they have different bandwidth (and thus speed) in both directions. An example of the use of xDSL technology is the provision of faster access to subscribers to the Internet, as well as to provide access to consumer services that benefit from high-speed access, such as video-on-demand.

To enable xDSL services to be communicated over existing subscriber loops, the central office facility 12 also includes a DSL access module (DSLAM) 32 coupled to the subscriber loops. The DSLAM 32 provides an interface between the subscriber loop and a packet data network 52. For other types of data services, other types of access modules are included in the central office facility 12.

The DSLAM 32 includes a splitter 72 that routes telephony signals (e.g., voice signals, dialed digits, etc.) to line cards 70 in the switch 16, and routes data signals to the packet data network 52.

The communications network 10 of FIG. 1 also includes another central office facility 14, which includes a switch 36 coupled to the switch 16 in the central office facility 12 over a voice trunk network 34. The switch 36 that routes signaling and voice payload of subscriber stations 38, 40, and 42. Voice data between the switches 16 and 36 are communicated over the voice trunk network 34. Although not shown, other central office switches are also coupled to the voice trunk network 34 to enable voice communications in telephone calls between various subscriber stations.

The central office switch 36 is connected to MDFs 44 and 46. The MDF 44 is coupled to subscriber stations 38 over respective subscriber loops, while the MDF 44 is coupled to the subscriber station 40 through an intermediate system 48. The intermediate system 48 can be any one of the intermediate systems listed for system 30 above. The MDF 46 is also coupled to subscriber stations 42 over respective subscriber loops.

The central office facility 14 also includes a DSLAM 50 that enables xDSL services for subscriber stations 38 and 42, assuming the subscriber loops associated with such subscriber stations 38 and 42 are qualified for xDSL services. Due to the presence of the intermediate system 48, the subscriber loop between the MDF 44 and the subscriber station 40 is incompatible with xDSL services.

Each of the MDFs 44 and 46 includes a respective splitter 76 and 78 for splitting telephony signals (which are routed to line cards 74 in the switch 36) and data signals to the DSLAM 50.

Each of the DSLAMs 32 and 50 provides a connection to the packet data network 52. Examples of the packet data network 52 include private networks such as local area networks (LAN) or wide area networks (WAN), or a public network such as the Internet. Thus, through the DSLAMs 32 and 50 in the central office facilities 12 and 14, certain of the subscriber stations in FIG. 1 are able to perform communications over the packet data network 52. Examples of such communications include electronic mail, web browsing, file transfers, packet-switched voice sessions, electronic gaming sessions, and so forth.

In accordance with some embodiments of the invention, a loop qualification system 54 is also coupled to the data network 52. The loop qualification system 54 is used by an operator, such as a service provider, to determine if subscriber loops between a central office (e.g., central office 12 or 14) and a subscriber station are eligible for high-speed data services (e.g., xDSL services). As used here, “high-speed data services” refers to data services with speeds or bandwidths that have the capacity to offer bit rates in the 128 kbps range upward into the Mega-bit per-second (“Mbps”) levels, which exceed those of traditional dial-up services using dial-up modems.

For example, SDSL can offer up to 2.3 Mbps on the downstream information-bearing channel and the upstream channel. ADSL can provide backward compatibility with legacy networks, and can offer downstream channel bandwidth in T-1/E1 increments (NxT-1/E1), which in the United States, the minimum configuration is T-1 at 1.536 Mbps of usable bandwidth; higher-speed configurations at 3.072 Mbps, 4.608 Mbps and 6.144 Mbps. Outside the United States, the downstream channel is either offered up to 2.0608 Mbps or 6.144 Mbps. The upstream capabilities of ADSL are through full duplex (bi-directional) channels, which include the “C Channel” for POTS, and an optional channel for purposes which include data communications and video conferencing. The C Channel is either 16 Kbps or 64 Kbps. These examples are provided for illustrative purposes only, and are not intended to limit the scope of the invention.

To perform loop qualification, the loop qualification system 54 uses information stored in a high-speed access table 56, which contains records reflecting the physical characteristics of the subscriber loops between the various central office facility equipment and respective subscriber stations. The high-speed access table 56 is located in a database system 57 that is coupled to the data network 52. The loop qualification system 54 accesses the table 56 using queries communicated over the data network 52.

In another embodiment, the high-speed access table 56 is stored on a storage device (e.g., a disk drive, compact disk drive, digital video disk drive, etc.) that is part of, or directly connected to, the loop qualification system 54. One or more test equipment 58 and 60 are also coupled to the central office facilities 12 and 14 for performing loop qualification. The loop qualification system 54 works in conjunction with the test equipment 58 and 60 to determine if a subscriber loop (or group of subscriber loops) is eligible for high-speed data services, and if so, the approximate bandwidth or data communications speed (or bit-rate) offered by the respective subscriber loops. As noted above, the loop qualification is based on records contained in the high-speed access table 56. As used here, “speed” or “data communications speed” refers to the rate of data (bits, bytes, words, double words, etc.) transfer over a communications channel. “Bandwidth” refers to the capacity of the communications channel for data transfer, which is dependent on the data communications speed and width of the communications channel.

The records in the high-speed access table 56 contain information regarding the physical characteristics of the subscriber loops and services deployed on the subscriber loops, with examples of such information including the identity (type) of equipment installed for a subscriber loop and the make-up of the subscriber loop (such as its length, gauge size, insulation type, installation type, and other information, described further below).

An aspect impeding the performance of loop qualification is that inaccurate records kept in the high-speed access table 56 causes the loop qualification process to be inaccurate. As a result, erroneous data speeds of subscriber loops may be calculated by the service provider in the loop qualification process. Some embodiments enable a service provider to discover the characteristics (both physical and electrical) of subscriber loops so that more accurate loop qualifications can be performed.

Technical support personnel can view contents of the high-speed access table 56 from a technical support system 62. The technical support system 62 is able to access values stored in the high-speed access table 56 over the data network 52. The technical support system 62 is also to communicate with the loop qualification system 54, which calculates an estimated bandwidth or speed of a given subscriber loop (or group of subscriber loops) based on records contained in high-speed access table 56. The loop qualifications system 54 is able to communicate with a monitoring system 51, which determines the actual bandwidth or speed of the subscriber loop (or group of subscriber loops) by querying equipment (e.g., the DSLAM) in the central office facility 12 or 14. A comparison is made between the estimated bandwidth or speed and the actual bandwidth or speed to determine any discrepancy, and the records in the high-speed access table 56 are updated accordingly to enhance accuracy of the high-speed access table 56 records. In one arrangement, an operator manually updates the content of the high-speed access table 56. In another arrangement, software running in the loop qualification system 54 or technical support system 62 is able to automate the update of content of the high-speed access table 56.

Although shown as separate systems, the technical support system 62 and loop qualification system 54 can be integrated into one system in another embodiment. In yet another alternative embodiment, multiple technical support systems are coupled to the data network 52.

According to one example, the records pertaining to subscriber loops in the high-speed access table 56 are as follows:

Access Table

| | | | | | | Large |
|---|---|---|---|---|---|---|
| | | | | Large | Small | Gauge |
| NEI Code | Site Name | Region | Distance | Gauge | Gauge | Insulation |
| Small | | | Large | Small | | % |
| Gauge | Large Gauge | Small Gauge | Gauge | Gauge | % | Small |
| Insulation | Install | Install | Filling | Filling | Large Gauge | Gauge |

The table includes various columns, which are discussed below. An NEI Code column contains the Common Language Location Identifier (CLLI), or other type of identifier, which is used in conjunction with a value in the Site Name column to uniquely identify the equipment of a service provider. The equipment can be a telephone switch or a DSLAM, as examples. The Site Name column identifies if a switch is at a host location or a remote location. An example of equipment at a host location is a switch located at a central office facility. An example of remote equipment is equipment that is remote from a central office facility, such as an access node that enables access by remote subscriber stations.

Another column in the table is a Region column, which identifies the physical location of a switch or DSLAM. The Region field is used as an index to an Environment Temperature Setup table 53 (also stored in the database system 57) to identify the environment temperature based on the region in which the switch or DSLAM is located. As noted above, electrical characteristics of a subscriber loop depend on the surrounding temperature.

A Distance column contains a value that represents the estimated length of wiring from a line card in the switch or DSLAM to the MDF. This distance is taken into account when calculating the upstream speed and the downstream speed of a subscriber loop (or group of subscriber loops). As the loop length measured through the test equipment 58 or 60 is between the MDF and the subscriber station at each customer premise, adding the loop length between the MDF and the DSLAM or switch takes into account the entire loop length between the switch or DSLAM and the customer premise equipment for estimating upstream and downstream bit-rates.

A Gauge column defines the wire gauge or the diameter of the cable between the DSLAM or switch and the MDF. The thicker the cable wire, the lower the attenuation of signaling in the cable, and hence, the higher the speed for medium and long subscriber loops. In North America, the wire gauges used are 26, 24, 22, and 19 AWG (American Wire Gauge). The 26 AWG is the thinnest wire and the 19 AWG is the thickest wire. However, other cable gauges can also be used.

Many subscriber loops are divided into a large gauge segment and a small gauge segment. The large gauge segment refers to the segment of a cable that has a larger gauge, while a small gauge segment refers to the segment of the cable that has a smaller gauge. The large gauge segment typically refers to the distribution section of the cable. The small gauge segment refers to the feeder section of the cable. The Large Gauge column of the Access table refers to the gauge of the large gauge section of the cable, while the Small Gauge column refers to the gauge of the small gauge section of the cable.

Large Gauge and Small Gauge Insulation columns in the Access table contain values for indicating the types of cable insulation of the large and small gauge segments, respectively, of the subscriber loop (or group of subscriber loops). The choices are plastic insulated or paper insulated. Paper insulated cable produces high attenuation at the high-frequency end of the xDSL transmission range. Therefore, estimated speeds are lower for paper-insulated cables than plastic insulated cables.

The next columns are a Large Gauge Install column and a small Gauge Install column, which indicates the cable installation method for the large gauge segment and small gauge segment, respectively. The choices are underground, aerial, or buried. The Install fields along with the Region field determine the environment temperature of the cable(s) making up the subscriber loop or group of subscriber loops. The higher the environment temperature around a cable, the higher the attenuation of signals in the cable. The temperature of the underground cable remains relatively constant. The temperature of a buried cable changes with environment temperature, but stays some amount of temperature (e.g., 10° F.) below the environment temperature. The temperature of an aerial cable changes with environment temperature, but stays some amount of temperature (e.g., 68° F.) above the environment temperature.

The Access table also includes a Large Gauge Filling column that defines the filling of the cable in the distribution (or large gauge) section. The filling can be either air core or jelly filled. Due to the different dielectric constants of air and jelly, the capacitance per length of a jelly-filled cable is higher than the capacitance per length of an air-filled cable. A Small Gauge Filling column indicates the filling of the cable in the feeder (or Small Gauge) section.

The Access table also includes a % Large Gauge column and a % Small Gauge column, to indicate the percentages of the distribution and feeder sections of the cable. For example, if a cable has a total length of approximately 10,000 feet of which 2,000 feet is of a smaller gauge cable and 8,000 feet is of a larger gauge cable, the percentage of small gauge cable is 20%, while the percentage of large gauge cable is 80%.

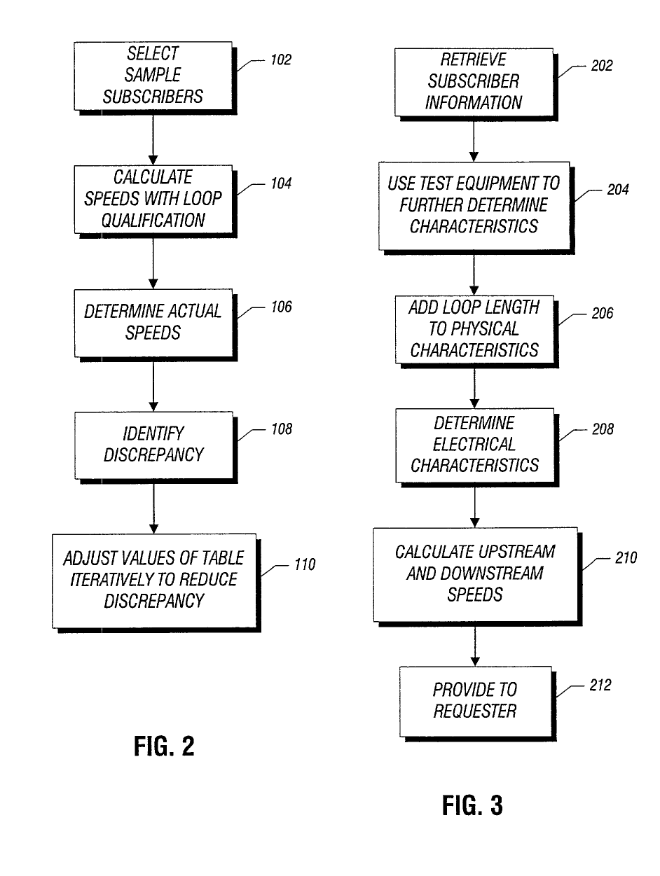

To discover if the contents of the high-speed access table 56 are accurate, the following process is performed, as illustrated in FIG. 2. A sample set of subscribers are selected (at 102). The sample set of subscribers already have xDSL service (e.g., the service was recently turned on and the service provider desires to verify that its records regarding the subscriber loop are accurate).

Next, using loop qualification, the estimated bandwidth or speed of each subscriber loop connected to customer premise equipment of a sample subscriber is calculated (at 104). This process involves a look up of various tables contained in the database system 57, as discussed further below in correction with FIG. 3.

Next, the actual bandwidth or speed of the subscriber loop is determined (at 106). The actual bandwidth or speed refers to the bandwidth or speed, measured at the DSLAM or other equipment, of a subscriber loop in transporting data between the DSLAM and the customer premise equipment. In one embodiment, as shown in FIG. 1, the monitoring system 51 is coupled to DSLAMs 32 and 50 to monitor speeds between the DSLAMs and respective subscriber stations. Thus, for each given subscriber loop, the monitoring system 51 can access the respective modem circuit in the corresponding DSLAM to determine the actual speed of the subscriber loop.

Once the actual speed is determined, the discrepancy between the actual speed and the calculated speed derived from loop qualification is determined (at 108). If a substantial discrepancy is found, such as a discrepancy above a predefined threshold, then values in the Access table discussed above are varied, with the process of FIG. 2 repeated to reduce the discrepancy between the actual speed of the subscriber loop and the calculated speed. This process is performed iteratively until the discrepancy has been reduced to an acceptable level.

The tweaking of the values can be done in one of two ways. In one embodiment, values are adjusted manually by an operator at the technical support system 62. Thus, in response to user entry of updated values in a user interface of the technical support system 62, the content of the Access table is updated. In an alternative embodiment, an automated procedure, provided by a software module, can be executed in the loop qualification system 54 or technical support system 62 to vary the values in the Access table for improving their accuracy in representing physical characteristics of a subscriber loop (or groups of subscriber loops).

As shown in FIG. 3, a loop qualification process in accordance with one embodiment is shown. Note that the loop qualification can be performed for a single subscriber loop or a group of subscriber loops. First, subscriber loop information is retrieved (at 202) from the Access table in the high-speed access table 56.

Given the various physical characteristics of each subscriber loop maintained in the Access table, the loop qualification system 54 works in conjunction (at 204) with test equipment 58 or 60 to further determine the loop length of the subscriber loop. The subscriber loop is probed using test signals from the test equipment 58 or 60 to detect for the presence of shorts, opens, and grounds. The test equipment 58 or 60 also probes the subscriber loop to measure resistance, capacitance, and AC and DC voltages. Use of test equipment to probe subscriber loops is described in U.S. Pat. No. 6,266,395, entitled “Single-Ended Subscriber Loop Qualification for xDSL Service,” by Gin Liu and Michael A. Campbell, which is incorporated herein by reference.

The calculated loop length is added (at 206) to the physical characteristics considered by the loop qualifications system 54 in the loop qualification process. Note that the high-speed access table 56 does not contain a field indicating the total length of the subscriber loop.

Given the physical properties of the cable, the resistance, inductance, capacitance, and conductance values at different frequencies can be determined (at 208). This can be performed by looking up a cable properties table 55 (FIG. 1), which provides representative values of R, L, G, and C for each combination of conductor gauge and insulation type, measured at specific temperatures and given a specific frequency. Given the values of R, L, G, and C at different a given frequency of the xDSL signal, the loop qualification system 54 can calculate a signal-to-noise ratio (SNR) for the subscriber loop. In one embodiment, two SNR values are generated: one for upstream xDSL signals and one for downstream xDSL signals. Once the upstream and downstream SNR values for a given frequency are known, than the corresponding upstream data communications speed and downstream data communications speed on the subscriber loop are calculated (at 210). The calculation of SNRs and associated data communications speeds of subscriber loops is described in greater detail in U.S. Pat. No. 6,266,395, referenced above. The calculated upstream and downstream speeds are communicated (at 212) to the requester of the information.

For ADSL, the wideband ADSL signal is divided into plural subchannels, with the SNR values calculated at the center frequency of each subchannel. From the SNR values of each subchannel, the upstream and downstream data communications speeds of the subchannel is determined. From the upstream and downstream data communications speeds of the subchannels, the upstream data communications speed and downstream data communications speed for the entire wideband ADSL signal are calculated, which are simple summations of all the respective upstream and downstream subchannel speeds.

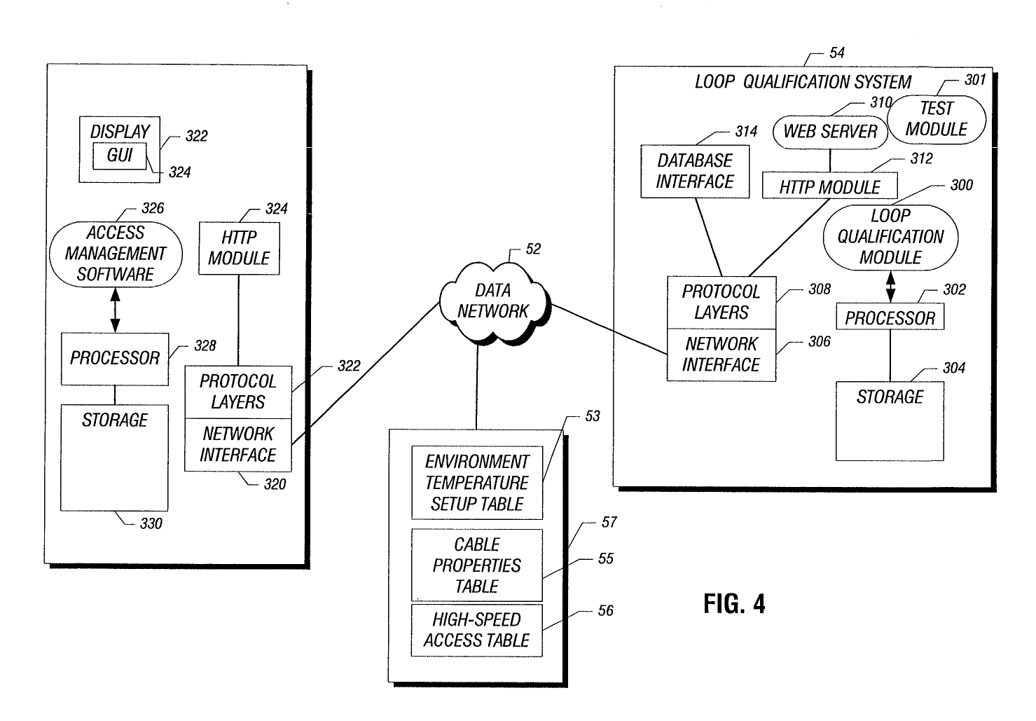

FIG. 4 shows some example components of the loop qualification system 54 and the technical support system 62. Note that the loop qualification system 54 and technical support system 62 can be combined in one system in another embodiment. The loop qualification system 54 includes a loop qualification module 300, which is a software module executable on a processor 302. The processor 302 is connected to a storage 304. The loop qualification module 300 performs loop qualification as discussed above in connection with FIG. 3. Also, a test module 301 is executable on the processor 302 for performing the subscriber loop records verification process described in connection with FIG. 2. The loop qualification module 300 and test module 301 may be part of the same software package.

The loop qualification system 54 also includes a network interface 306 that is configured for communications, over the data network 52. In one embodiment, the network interface 306 is an Ethernet adapter. In other embodiments, other types of network interfaces can be used. The network interface 306 is part of a protocol stack, in which various protocol layers 308 exist above the network interface 306. In one example, the protocol layers 308 include an UDP/IP (User Datagram Protocol/Internet Protocol) stack. UDP, described in RFC 768, entitled “User Datagram Protocol,” dated August 1980, is a transport layer for managing communications between network elements over an IP network. IP defines a packet-switched communications protocol, with one version of IP described in RFC 791, entitled “Internet Protocol,” dated September 1981. Another version of IP is described in RFC 2460, entitled “Internet Protocol Version 6 (IPv6) Specification,” dated December 1998. In other embodiments, other types of protocol layers 308 can be used.

In the example embodiment of FIG. 4, a web server module 310 also resides in the loop qualification system 54. The web server module 310 enables a remote system, such as the technical support system 62, to access a web page on the loop qualification system 54 to perform various tasks. To enable communications between the technical support system 62 and the loop qualification system 54, the loop qualification system 54 also includes an HTTP (HyperText Transfer Protocol) module 312. HTTP provides for requests and responses of predefined formats to enable communications over the data network 52 between a client (e.g., the technical support system 62) and a server (e.g., the loop qualification system 64). One version of the HTTP is described in RFC 2068, entitled “Hypertext Transfer Protocol-HTTP/1.1,” dated January 1997.

The loop qualification system 54 also includes a database interface 314 to enable requests to be sent over to data network 52 to the database system 57 (including the high-speed access table 56, cable properties table 55, and environment temperature setup table 53).

The technical support system 62 also includes a network interface 320, which is similar to the network interface 306 of the loop qualification system 54. Above the network interface 320 are network protocol layers 322. An HTTP module 325 also resides in the technical support system 62. An access management software 326 is executable on a processor 328 in the technical support system 62. The processor 328 is coupled to a storage 330.

The technical support system 62 also includes a display 332 that includes a user interface 324, such as a graphical user interface (GUI). The access management software 326 enables a user to perform access management of the communications network 10 (FIG. 1), which includes qualifying subscriber loops, retrieving records from the database system 57, determining if records contained in the high-speed access table 56 are accurate, modifying values of the table to enhance accuracy, and other tasks.

Instructions of the various software routines or modules discussed herein (such as the loop qualification module 300, test module 301, and access management software 326) are loaded for execution on corresponding control units or processors. The control units or processors include microprocessors, microcontrollers, processor modules or subsystems (including one or more microprocessors or microcontrollers), or other control or computing devices. As used here, a “controller” refers to hardware, software, or a combination thereof. A “controller” can refer to a single component or to plural components (whether software or hardware).

Data and instructions (of the various software routines or modules) are stored in respective storage devices, which are implemented as one or more machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

The instructions of the software routines or modules are loaded or transported to each system in one of many different ways. For example, code segments including instructions stored on floppy disks, CD or DVD media, a hard disk, or transported through a network interface card, modem, or other interface device are loaded into the device or system and executed as corresponding software routines or modules. In the loading or transport process, data signals that are embodied in carrier waves (transmitted over telephone lines, network lines, wireless links, cables, and the like) communicate the code segments, including instructions, to the system. Such carrier waves are in the form of electrical, optical, acoustical, electromagnetic, or other types of signals.

While the invention has been disclosed with respect to a limited number of embodiments, those skilled in the art will appreciate numerous modifications and variations there from. It is intended that the appended claims cover such modifications and variations as fall within the true spirit and scope of the invention.

What is claimed is:

1. A method of determining communications channel performance, comprising:
calculating a data communications speed of the communications channel based on records, used for high-speed access qualification;
determining an actual data communications speed of the communications channel; and
comparing the calculated data communications speed and the actual data communications speed to determine if the records are accurate.

2. The method of claim 1, further comprising generating a value for updating the records in response to a difference between the calculated data communications speed and actual data communications speed.

3. The method of claim 2, further comprising providing a user interface to display content of the records stored in the database.

4. The method of claim 3, wherein generating the value comprises receiving user modification of the content of the records displayed in the user interface.

5. The method of claim 1, wherein calculating the data communications speed of the communications channel comprises calculating the data communications speed of a Digital Subscriber Line subscriber loop.

6. The method of claim 5, wherein determining the actual data communications speed comprises accessing a value in a Digital Subscriber Line access module.

7. The method of claim 1, further comprising accessing the records in a database system, the records containing at least one of the following information: insulation type of a cable included in the communications channel; a percentage of a large gauge section of the cable; a percentage of a small gauge section of the cable; a gauge size of the large gauge section; a gauge size of the small gauge section of the cable; an installation technique of the large gauge section; and an installation technique of the small gauge section.

8. The method of claim 1, further comprising accessing the records in a database system, the records containing at least one of the following information: insulation type of a cable included in the communications channel; a percentage of a large gauge section of the cable; a percentage of a small gauge section of the cable; a gauge size of the large gauge section; a gauge size of the small gauge section of the cable; an installation technique of the large gauge section; an installation technique of the small gauge section; a filling type for the large gauge section; a filling type for the small gauge section; an indication of a region at which the cable is located; an indication of a distance of a communications channel segment between a Digital Subscriber Line access module and a wire distribution frame; and an indication of a gauge of a cable in the communications channel segment between the Digital Subscriber Line access module and wire distribution frame.

9. The method of claim 1, wherein calculating the data communications speed of the communications channel based on the records comprises calculating the data communications speed of the communications channel based on the records indicating physical characteristics of the communications channel.

10. The method of claim 9, wherein calculating the data communications speed further comprises determining electrical characteristics based on the records indicating physical characteristics of the communications channel.

11. The method of claim 10, wherein calculating the data communications speed comprises causing test equipment to probe the communications channel to determine a length of the communications channel.

12. The method of claim 10, wherein calculating the data communications speed of the communications channel comprises calculating the data communications speed of a Digital Subscriber Line subscribe loop.

13. The method of claim 1, further comprising:
calculating an updated data communications speed of the communications channel based on the updated records; and
comparing the updated data communications speed with the actual data communications speed to determine if a difference exists between the updated data communications speed and the actual data communications speed.

14. The method of claim 13, further comprising generating another value to update the records in response to the difference between the updated data communications speed and the actual data communications speed.

15. The method of claim 1, wherein calculating the data communications speed of the communications channel comprises calculating the data communications speed of a communications channel between customer premise equipment and an access module.

16. The method of claim 1, wherein calculating the data communications speed of the communications channel comprises calculating the data communications speed of a group of plural subscriber loops coupled to respective plural customer premise equipment.

17. An article comprising at least one storage medium containing instructions that when executed cause one or more systems to:
access records pertaining to characteristics of a communications channel;
determine variance between a predicted data communications speed of the communications channel based on the records and an actual data communications speed of the communications channel; and
update the records based on the determined variance.

18. The article of claim 17, wherein the instructions when executed cause the one or more systems to access the records pertaining to the characteristics of a Digital Subscriber Line subscriber loop.

19. The article of claim 18, wherein the instructions when executed cause the one or more systems to access records pertaining to the physical characteristics of Digital Subscriber Line subscriber loop.

20. The article of claim 17, wherein the instructions when executed cause the one or more systems to access records pertaining to the characteristics of a group of Digital Subscribe Line subscriber loops, the communications channel comprising the group of Digital Subscribe Line subscriber loops.

21. The article of claim 17, wherein the instructions when executed cause the one or more systems to further calculate the predicted data communications speed based on the records.

22. The article of claim 17, wherein the instructions when executed cause the one or more systems to further provide a graphical user interface to display the records.

23. The article of claim 22, wherein the instructions when executed cause the one or more systems to update the records in response to user input of one or more updated values.

24. The article of claim 17, wherein the instructions when executed cause the one or more systems to further determine the actual data communications speed by accessing a value in a Digital Subscribe Line access module.

25. The article of claim 17, wherein the instructions when executed cause the one or more systems to further perform a loop qualification process of the communications channel using the updated records to qualify the communications channel for Digital Subscribe Line data access.

26. A system comprising:
an interface adapted to access records pertaining to characteristics of a communications channel; and
a controller adapted to receive an estimated bandwidth of the communications channel that is calculated based on the records;
the controller adapted to receive an indication of an actual bandwidth of the communications channel;
the controller adapted to update the records to reduce a variance between the calculated bandwidth and the estimated bandwidth.

27. The system of claim 26, wherein the communications channel comprises a Digital Subscriber Line subscriber loop.
